(19) United States
(12) Patent Application Publication
(10) Pub. No.: US 2025/0105309 A1
(43) Pub. Date: Mar. 27, 2025

(54) NITROGEN-DOPED COMPOSITE HAVING HIGH DEGREE OF ORDERING, AND METHOD FOR PRODUCING THE SAME

(71) Applicant: Daegu Gyeongbuk Institute of Science and Technology, Daegu (KR)

(72) Inventors: Jong-Sung YU, Seoul (KR); Muhammad Irfansyah MAULANA, Daegu (KR)

(73) Assignee: Daegu Gyeongbuk Institute of Science and Technology, Daegu (KR)

(21) Appl. No.: 18/891,587

(22) Filed: Sep. 20, 2024

(30) Foreign Application Priority Data
Sep. 26, 2023 (KR) 10-2023-0128852

(51) Int. Cl. H01M 4/92; C25B 11/054; C25B 11/065; C25B 11/091

(52) U.S. Cl. CPC H01M 4/926; H01M 4/921; C25B 11/054; C25B 11/065; C25B 11/091

(57) ABSTRACT

Provided are a nitrogen-doped composite having a high degree of ordering and a method for producing the same. The composite includes a carbon support and a nitrogen-doped nanoparticle supported on the carbon support, wherein the nanoparticle includes an alloy including platinum and a metal other than platinum and has a coercivity of 7 kOe or more.

### CROSS-REFERENCE TO RELATED APPLICATION

This application claims priority under 35 U.S.C. § 119 to Korean Patent Application No. 10-2023-0128852, filed on Sep. 26, 2023, in the Korean Intellectual Property Office, the disclosure of which is incorporated herein by reference in its entirety.

### STATEMENT REGARDING COLOR DRAWINGS

The present application contains at least one drawing executed in color. Copies of this patent or patent application publication with color drawings will be provided by the United States Patent and Trademark Office (USPTO) upon request and payment of the necessary fee.

### TECHNICAL FIELD

The following disclosure relates to a nitrogen-doped composite having a high degree of ordering, a method for producing the same, and an energy conversion device comprising the composite.

### BACKGROUND

Fuel cells and water electrolysis cells, which are eco-friendly energy conversion devices, essentially use catalysts to improve energy conversion efficiency.

For example, in the case of proton exchange membrane fuel cells (PEMFC), platinum (Pt) is mainly used as a catalyst to promote an oxygen reduction reaction (ORR) at cathodes and a hydrogen oxidation reaction (HOR) at anodes. In particular, the oxygen reduction reaction at cathodes is slower than the hydrogen oxidation reaction at anodes, and since a reaction speed thereof determines the performance of the entire fuel cell, a pure platinum catalyst is currently mainly used to promote the oxygen reduction reaction at cathodes.

However, due to the high price and scarcity of platinum, which is a precious metal, there is a limit in large-scale application. To overcome this, research on platinum-based alloy catalysts obtained by alloying platinum with a second metal, such as, cobalt, nickel, iron, manganese, or copper has been actively conducted, but improvements are still needed in terms of activity, durability, and economy.

Therefore, in order to increase the efficiency of fuel cells, it is necessary to provide an economical catalyst along with improved catalyst activity and durability.

### SUMMARY

An example embodiment of the present disclosure is directed to providing a composite having excellent catalytic activity and significantly improved durability, and a method for producing the composite.

Another object is to provide an electrode comprising the composite of the present disclosure.

Another object is to provide an energy conversion device comprising the electrode of the present disclosure.

In one general aspect, a composite comprises: a carbon support and a nitrogen-doped nanoparticle supported on the carbon support, wherein the nanoparticle comprises an alloy comprising platinum and a metal other than platinum and has a coercivity of 7 kOe or more.

The metal other than the platinum may be at least one metal selected from the group consisting of vanadium (V), chromium (Cr), iron (Fe), ruthenium (Ru), cobalt (Co), rhodium (Rh), iridium (Ir), nickel (Ni), palladium (Pd), copper (Cu), molybdenum (Mo), tungsten (W), yttrium (Y), scandium (Sc), zirconium (Zr), niobium (Nb), zinc (Zn), silver (Ag), gold (Au), antimony (Sb), cerium (Ce), and lanthanum (La).

The alloy may be an intermetallic compound of platinum and a metal other than platinum.

The composite may have a peak in a range of 20-33.32+1° in an X-ray diffraction (XRD) spectrum.

The composite may have a proportion of the degree of ordering of 40% or more.

A ratio (I₁/I₂) of a maximum peak intensity (I₁) appearing in an X-ray absorption near-edge structure (XANES) spectrum of the composite to a maximum peak intensity (I₂) appearing in a spectrum of pure platinum (Pt) may be 1.3 or less.

In the composite, a preservation rate of metals other than platinum measured after etching in a 0.1 M of perchloric acid (HClO₄) solution for 24 hours may be 70% or more.

The nanoparticle may comprise 1 to 20 atomic % of nitrogen.

A chemical bond may be formed with nitrogen and a metal other than platinum.

The nanoparticle may have an average particle diameter of 0.1 to 20 nm.

The composite may further comprise: a platinum shell on a surface of the nanoparticle

The composite may be a catalyst for an oxygen reduction reaction.

In another general aspect, a method for producing a composite comprises: an operation (S1) of producing a first alloy particle supported on a carbon support from a reaction solution comprising a carbon support, a platinum precursor, and a metal precursor other than platinum; an operation (S2) of producing a nitrogen-doped second alloy particle by first heat treatment of the first alloy particle under a nitrogen-containing gas; and an operation (S3) of secondary heat treatment of the nitrogen-doped second alloy particle under a reducing atmosphere.

A coercivity of the first alloy particle and the nitrogen-doped second alloy particle may be less than 1 kOe, and coercivity of the composite may be 7 kOe or more.

The reaction solution of the operation (S1) may further comprise a surface stabilizer.

The first heat treatment of the operation (S2) may be performed at 300 to 600° C.

The reducing atmosphere of the operation (S3) may comprise hydrogen.

The secondary heat treatment of the operation (S3) may be performed at 600 to 1000° C.

In another general aspect, an electrode comprising the composite described above is provided.

In another general aspect, an energy conversion device comprising the electrode described above is provided.

In an example embodiment, the energy conversion device may have a retention rate of maximum power density of 85% or more after an accelerated durability test of 30,000 cycles.

In an example embodiment, the energy conversion device may have a retention rate of electrochemically active surface area of 60% or more after the accelerated durability test of 30,000 cycles.

In an example embodiment, the energy conversion device may have a retention rate of activity per unit mass at 0.9 V of 60% or more after the accelerated durability test of 30,000 cycles.

Other features and aspects will be apparent from the following detailed description, the drawings, and the claims.

### BRIEF DESCRIPTION OF THE DRAWINGS

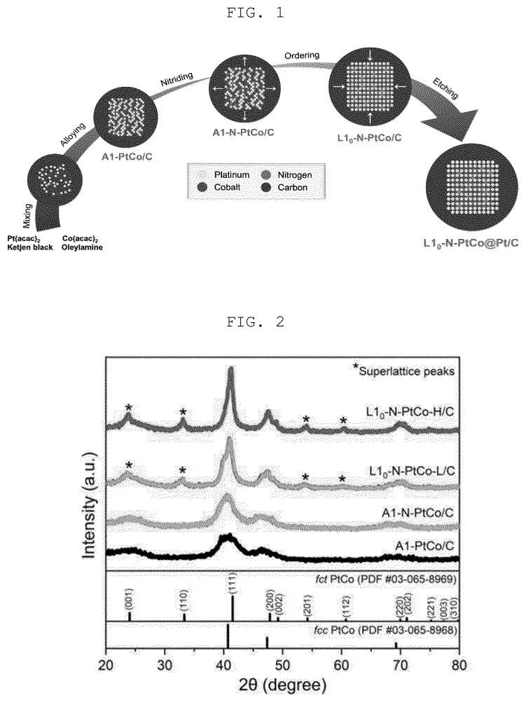

FIG. 1 is a schematic diagram illustrating a series of processes of producing a composite according to an example embodiment of the present disclosure.

FIG. 2 is a diagram illustrating XRD patterns of Comparative Examples 1 to 3 and Example 1.

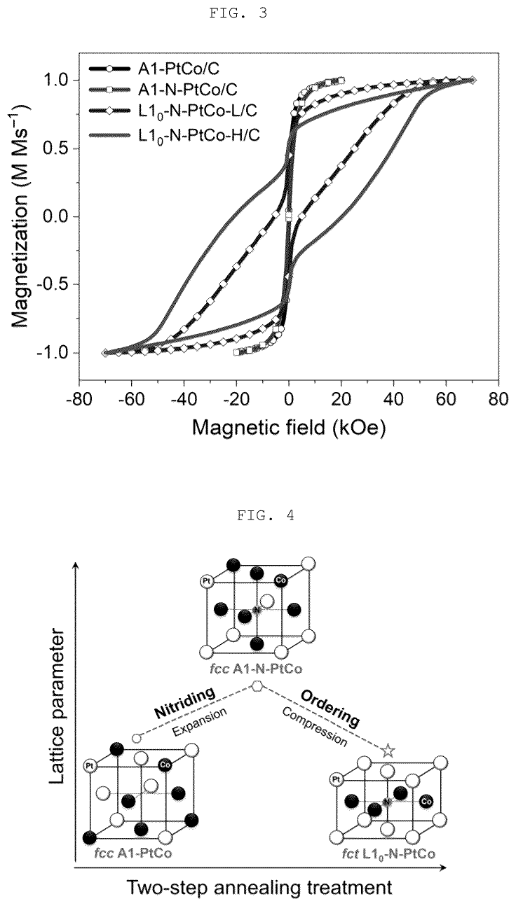

FIG. 3 is a diagram illustrating magnetic hysteresis loops of Comparative Examples 1 to 3 and Example 1.

FIG. 4 is a unit cell schematic model illustrating changes in lattice parameters and atomic arrangements according to first and second heat treatments of Example 1.

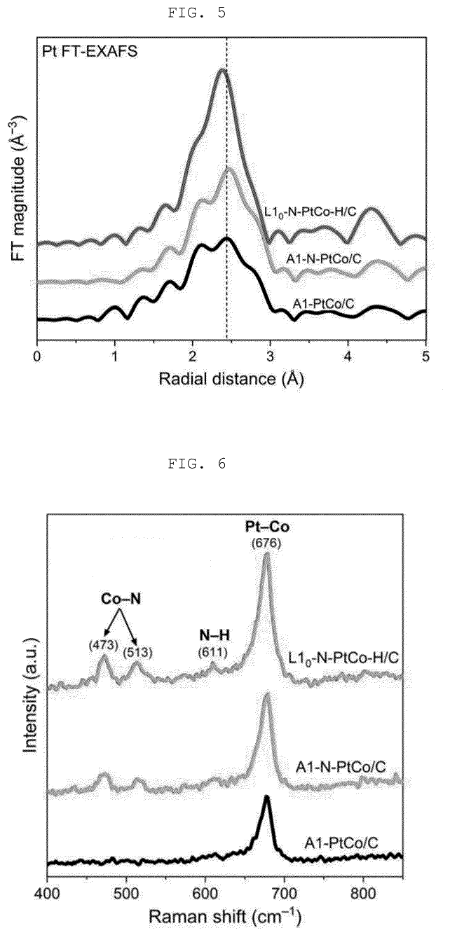

FIG. 5 is a diagram illustrating Pt L₃-edge FT-EXAFS spectra of Comparative Example 1, Comparative Example 2, and Example 1.

FIG. 6 is a diagram illustrating Raman spectra of Comparative Example 1, Comparative Example 2, and Example 1.

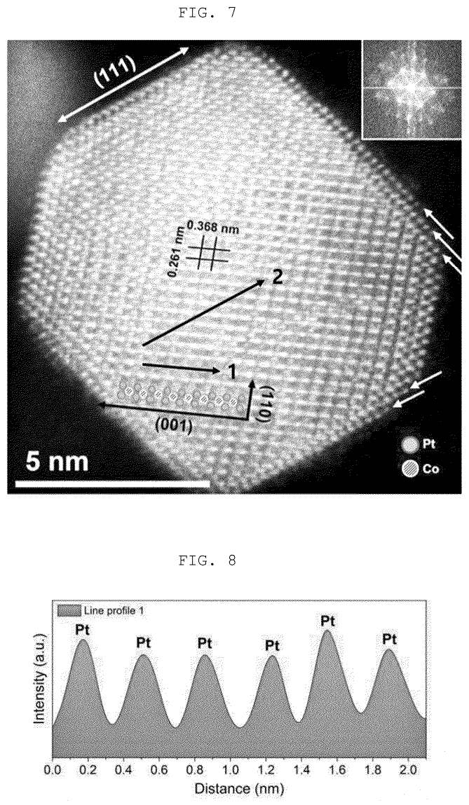

FIG. 7 is a diagram illustrating an atomic resolution HAADF-STEM image of a composite having a core-shell structured of Example 5.

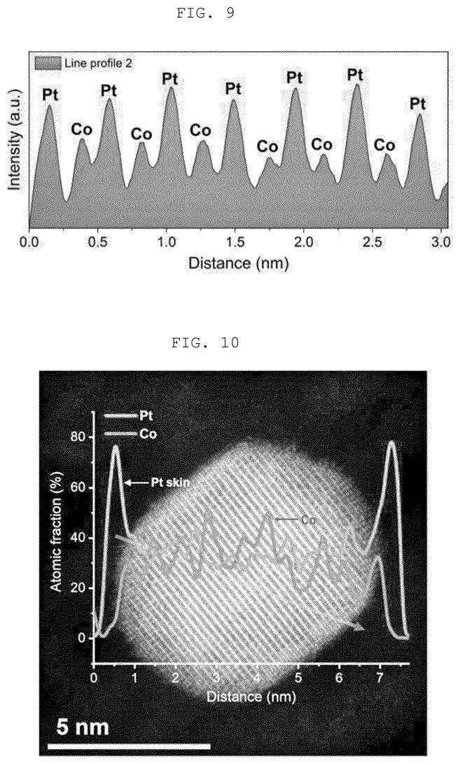

FIGS. 8 and 9 are drawings illustrating intensity profiles at line profiles 1 and 2 shown in FIG. 7, respectively.

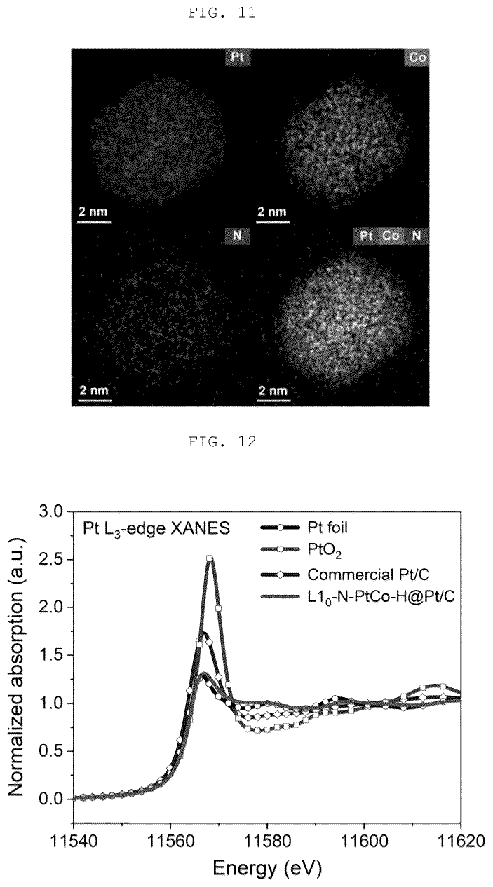

FIGS. 10 and 11 are drawings illustrating composition profiles and EDS element mapping images of Pt and Co at lines shown in the HAADF-STEM image, respectively.

FIG. 12 is a drawing illustrating Pt L₃-edge XANES spectra of each of Pt foil, PtO₂, commercial Pt/C, and Example 5.

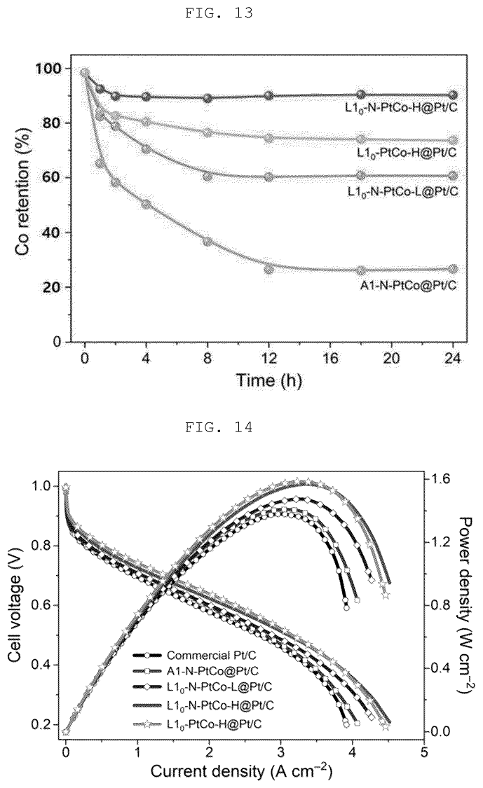

FIG. 13 is a drawing illustrating the results of evaluating chemical stability of composites of Example 5 and Comparative Examples 6 to 8.

FIG. 14 is a drawing illustrating polarization curves and power density curves of fuel cells to which Example 5 and Comparative Examples 6 to 9 were applied as cathode catalysts, respectively.

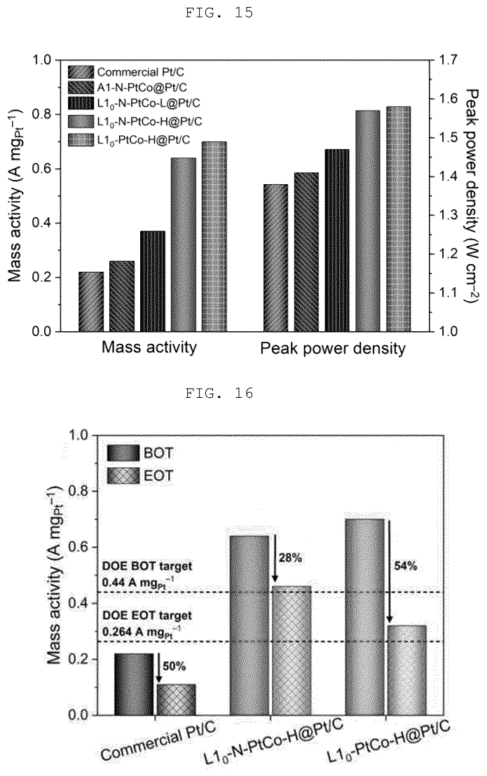

FIG. 15 is a diagram illustrating the mass activity (i.e., activity per unit mass) and peak power density (Pmax) at 0.9 V of the fuel cells to which Example 5 and Comparative Examples 6 to 9 were applied as cathode catalysts, respectively.

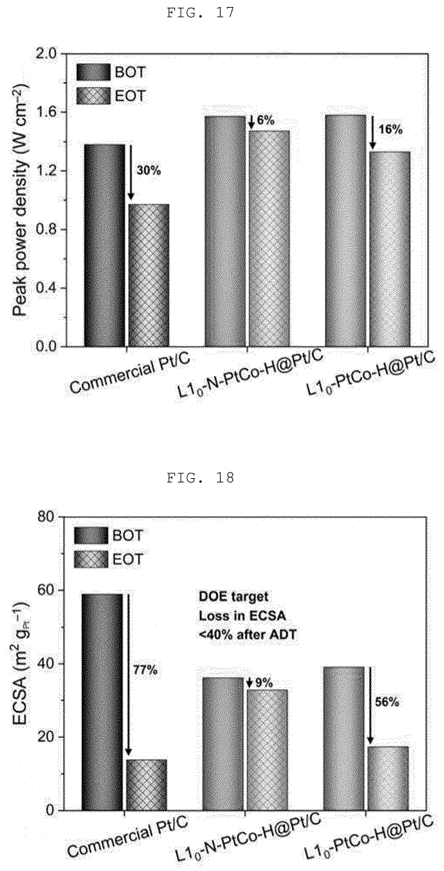

FIGS. 16 to 18 are diagrams illustrating the performance at a start point (BOT) and an end point (EOT) of ADT performed for 30 k cycles of the fuel cells to which Example 5, Comparative Example 8 and Comparative Example 9 were applied as cathode catalysts, respectively.

FIG. 19 is a diagram illustrating voltage loss according to the ADT performance of the fuel cells to which Example 5, Comparative Example 8, and Comparative Example 9 were applied as cathode catalysts, respectively.

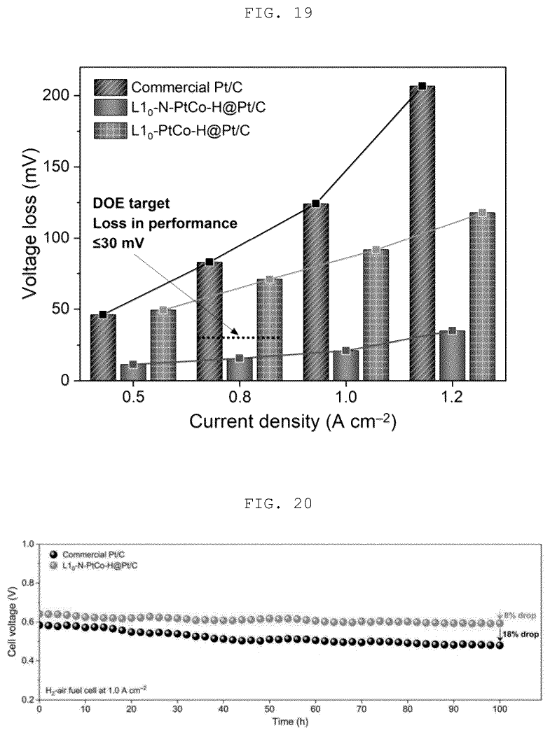

FIG. 20 is a diagram illustrating the results of the long-term steady-state evaluation of fuel cells to which Example 5 and Comparative Example 9 were applied as cathode catalysts.

### DETAILED DESCRIPTION OF EXAMPLE EMBODIMENTS

The example embodiments may be exemplified in many different forms and should not be construed as being limited to the specific example embodiments set forth herein. In addition, these example embodiments are provided so that this disclosure will be thorough and complete, and will fully convey the scope of the inventive concept to those skilled in the art.

In addition, a singular form used in the present specification may be intended to also comprise a plural form, unless otherwise indicated in the context.

A numerical range used in the present specification comprises all values within the range comprising the lower limit and the upper limit, increments logically derived in a form and span in a defined range, all double limited values, and all possible combinations of the upper limit and the lower limit in the numerical range defined in different forms. Unless otherwise defined in the specification of the present disclosure, values which may be outside a numerical range due to experimental error or rounding of a value are also comprised in the defined numerical range.

In addition, unless explicitly described to the contrary, the word “comprise”, and variations, such as “comprises” or “comprising”, will be understood to imply the inclusion of stated elements but not the exclusion of any other elements.

It will be understood that when an element, such as a layer, film, region, or substrate is referred to as being “on” another element, it may be directly on the other element or intervening elements may also be present.

Terms, such as first, second, and the like may be used to describe various components and the components should not be limited by the terms. The terms are used only to discriminate one constituent element from another component.

A composite according to the present disclosure comprises a carbon support and a nitrogen-doped nanoparticle supported on the carbon support, wherein the nanoparticle comprises an alloy comprising platinum and a metal other than platinum and has coercivity of 7 kOe or more. Hereinafter, for convenience, the metal other than platinum may be expressed as a first metal.

Since the composite has a high degree of ordering and comprises nitrogen-doped alloy nanoparticles, an interaction between platinum and the first metal and between nitrogen and the first metal may increase to have significantly improved catalytic activity and durability. Specifically, the composite may improve catalytic activity by inducing a strong interaction between platinum and the first metal as the degree of ordering increases and changing a lattice configuration. In addition, the composite may effectively suppress an elution phenomenon of the first metal, which causes a decrease in durability, by inducing the strong interaction between platinum and the first metal by nitrogen doping.

In an example embodiment, the composite may have a coercivity of 7 kOe or more, 10 kOe or more, 15 KOe or more, 20 kOe or more, 40 kOe or less, 30 kOe or less, or 25 kOe or less, and specifically, 7 to 40 kOe, 10 to 40 kOe, 15 to 30 kOe, or 20 to 25 kOe. The coercivity is a property proportional to the degree of ordering, and when the composite has a coercivity in the aforementioned range, excellent catalytic activity and durability may be realized. Here, the coercivity may be calculated from magnetic hysteresis loops, and specifically, may be measured using a magnetic property measurement system (MPMS) using Quantum Design/MPMS3 having a field of up to 70 kOe, but is not necessarily limited thereto.

In an example embodiment, the first metal, which is a metal other than platinum, may be at least one metal selected from the group consisting of vanadium (V), chromium (Cr), iron (Fe), ruthenium (Ru), cobalt (Co), rhodium (Rh), iridium (Ir), nickel (Ni), palladium (Pd), copper (Cu), molybdenum (Mo), tungsten (W), yttrium (Y), scandium (Sc), zirconium (Zr), niobium (Nb), zinc (Zn), silver (Ag), gold (Au), antimony (Sb), cerium (Ce), and lanthanum (La), and may be, specifically, iron (Fe), ruthenium (Ru), cobalt (Co), nickel (Ni), or copper (Cu), and more specifically, cobalt (Co).

In an example embodiment, the alloy may be an intermetallic compound of platinum and the first metal. That is, the alloy may be an intermetallic compound formed by combining platinum with the first metal at a specific integer ratio. Accordingly, the composite may more excellently achieve the effect of increasing catalytic activity as platinum and the first metal occupy specific positions in a crystal lattice of the alloy.

In an example embodiment, the composite may have an L1₀-type face-centered tetragonal (fct) structure or an L1₂-type face-centered cubic (fcc) structure, and specifically, may have an L1₀-type face-centered tetragonal (fct) structure.

In an example embodiment, the composite may have a first peak in the range of 2θ=33.32±1° in an X-ray diffraction (XRD) spectrum. In addition, the composite may further have a second peak in the range of 2θ=24.03±1° in the XRD spectrum. Since the composite has a superlattice structure having the first peak and/or the second peak, a strong interaction between platinum and the first metal may be induced to change the lattice configuration to improve catalytic activity.

In an example embodiment, a proportion of the degree of ordering of the composite may be 40% or more, specifically 50% or more, 60% or more, or 70% or more, and an upper limit thereof may be 85% or less, 90% or less, or 95% or less. In this case, the proportion (%) of the degree of ordering may be a value obtained by dividing the degree of ordering of the composite calculated by the formula below by an ideal degree of ordering of a platinum/first metal alloy having the L1₀-type fct structure to obtain a resultant value and then multiplying the resultant value by 100.

The degree of ordering=S₍₁₁₀₎/(S₍₁₁₁₎+S₍₂₀₀₎+S₍₀₀₂₎)

S₍₁₁₀₎, S₍₁₁₁₎, S₍₂₀₀₎, and S₍₀₀₂₎ above indicate integrated areas of the peaks (110), (111), (200), and (002), respectively, appearing in the X-ray diffraction (XRD) spectrum.

In an example embodiment, the ratio (I₁/I₂) of the intensity (I₁) of the maximum peak appearing in an X-ray absorption near-edge structure (XANES) spectrum of the composite and the intensity (I₂) of the maximum peak appearing in the spectrum of pure platinum (Pt) may be 1.3 or less, specifically 1.2 or less, and more specifically 1.1 or less. Since the composite satisfies the aforementioned range, the ratio of the metallic platinum component among the platinum comprised in the composite may be significantly high, thereby obtaining better catalytic activity and durability.

In an example embodiment, a retention rate of the first metal measured after etching the composite in a 0.1 M of perchloric acid (HClO₄) aqueous solution for 24 hours may be 70% or more, specifically 80% or more. 85% or more, or 90% or more. The composite may satisfy the retention rate of the first metal in the aforementioned range, so that an elution phenomenon of the first metal, which causes a decrease in durability, may be effectively suppressed. Here, the etching may be performed at 60° C. The retention rate may be a value obtained by dividing the number of atoms of the first metal after etching under the aforementioned conditions by the number of atoms of the first metal before etching to obtain a resultant value and then multiplying the resultant value by 100.

In an example embodiment, the nanoparticle may comprise 1 to 20 at % of nitrogen, specifically 5 to 15 at % of nitrogen.

In an example embodiment, the nanoparticle may comprise 1 to 20 at % of nitrogen, 30 to 50 at % platinum, and 30 to 50 at % of first metal. Specifically, the nanoparticle may comprise 5 to 15 at % of nitrogen, 40 to 50 at % of platinum, and 40 to 50 at % of the first metal.

In an example embodiment, the nitrogen may be doped onto the nanoparticle, and specifically, a chemical bond may be formed between the nitrogen and the first metal. Since the composite comprises the chemical bond between nitrogen and the first metal, an elution phenomenon of the first metal, which degrades durability, may be more effectively suppressed.

In an example embodiment, the nanoparticle may have an average particle diameter (D50) of 0.1 to 20 nm, specifically. I to 15 nm, and more specifically, 2 to nm, but is not necessarily limited thereto.

In an example embodiment, the composite may further comprise a platinum shell on the surface of the nanoparticle. That is, the composite may have a core-shell structure comprising a nitrogen-doped core and a platinum shell located on the core within the nanoparticle as described above. The platinum shell may be a stack structure in which 1 to 10, specifically 1 to 6, and more specifically 1 to 3 single atomic layers are stacked based on a single atomic layer formed of platinum atoms. Since the composite has a core-shell structure comprising the nitrogen-doped core and the platinum shell with a high degree of ordering, the interaction between platinum and the first metal and between nitrogen and the first metal may increase, and at the same time, the lattice mismatch between the core and the shell region may increase, thereby having better catalytic activity and durability.

In an example embodiment, the carbon support comprised in the composite may be used without limitation as long as it is a carbon support comprising carbon with excellent chemical stability and electrical conductivity known in the art. For example, the carbon support may be at least one selected from Vulcan carbon, carbon paper, carbon filter, carbon fiber, acetylene black, carbon black, Ketjen black, carbon nanotube, graphene, timcal, and carbon doped with heteroatoms, but is not particularly limited thereto.

The total content of the metal comprising platinum and the first metal supported on the carbon support may be 1 to 60 wt %, specifically 4 to 40 wt %, and more specifically 5 to 30 wt %, based on the total weight of the composite, but is not necessarily limited thereto.

In an example embodiment, the composite may be a catalyst for an oxygen reduction reaction (ORR). As described above, the composite having a high degree of ordering with a coercivity of 7 kOe or more and comprising nitrogen-doped nanoparticles may be used as a catalyst for an oxygen reduction reaction having remarkably excellent activity and stability in the oxygen reduction reaction.

A method for producing a composite according to an example embodiment may comprise: an operation (S1) of producing a first alloy particle supported on a carbon support from a reaction solution comprising a carbon support, a platinum precursor, and a metal precursor other than platinum; an operation (S2) of first heat treatment of the first alloy particle under a nitrogen-containing gas to produce a nitrogen-doped second alloy particle; and an operation (S3) of secondary heat treatment of the nitrogen-doped second alloy particle under a reducing atmosphere.

According to the method for producing the composite, the composite as described above may be produced in a simple manner, and the composite produced by the aforementioned producing method may comprise alloy nanoparticles having a high degree of ordering and doped with nitrogen, thereby increasing the interaction between platinum and the first metal and between nitrogen and the first metal to have significantly improved catalytic activity and durability.

In the method for producing a composite according to an example embodiment, the carbon support and metal other than platinum of the metal precursor other than platinum may be applied as described above, so a detailed description thereof is omitted.

The first alloy particle and the second alloy particle produced by the operations (S1) and (S2) may have no or significantly low degree of ordering, and the composite produced by the operation (S3) may have a significantly high degree of ordering.

Specifically, the coercivity of the first alloy particle and the nitrogen-doped second alloy particle may be less than 1 kOe, and the coercivity of the composite may be 7 kOe or more. More specifically, the coercivity of the first alloy particle and the second alloy particle may be 0 kOe, and the coercivity of the composite may be 7 kOe or more, 10 kOe or more, 15 kOe or more, 20 kOe or more, 40 kOe or less, 30 kOe or less, or 25 kOe or less, and specifically, may be 7 to 40 kOe, 10 to 40 kOe, to 30 kOe, or 20 to 25 kOe. In an example embodiment, the reaction solution of the operation (S1) may further comprise a surface stabilizer. The surface stabilizer may be at least one selected from the group consisting of oleylamine, oleic acid, octylamine, hexadecylamine, octadecylamine, trioctylphosphine oxide (TOPO), trioctylphosphine (TOP), and tributylphosphine, and may be specifically oleylamine. In the operation (S1), the platinum precursor (or a first metal precursor) may be an acetylacetonate compound, an acetate compound, an oleate compound, a stearate compound, a chloride, an iodide, a sulfide, a fluoride, a hydroxide, a carbonate, or a nitrate comprising platinum (or the first metal). In an example embodiment, the operation (S1) is an operation of producing a first alloy particle supported on a carbon support from a reaction solution comprising a carbon support, a platinum precursor, and a first metal precursor, and may perform heating at a temperature of 150° C. or higher. In order to distinguish the heating from the heat treatments of operations (S2) and (S3), the heating of operation (S1) is referred to as a pre-heat treatment. As an example, the pre-heat treatment may be performed at 150 to 300° C. for 1 to 10 hours, and specifically, may be performed at 190 to 250° C. for 3 to 6 hours, but is not necessarily limited thereto. In an example embodiment, the first heat treatment of the operation (S2) may be performed at 300 to 600° C., and specifically, may be performed at 300 to 500° C., 350 to 500° C., or 400 to 500° C. A first heat treatment time may be changed by a heat treatment temperature, and may be, for example, 1 to hours or 1 to 5 hours, but is not necessarily limited thereto.

In an example embodiment, the nitrogen-containing gas of the operation (S2) may be at least one selected from the group consisting of ammonia, urea, and melamine, and specifically may be ammonia.

In an example embodiment, the reducing atmosphere of the operation (S3) may comprise hydrogen. Specifically, the reducing atmosphere may comprise an inert gas and hydrogen gas, and a volume ratio of the hydrogen gas and the inert gas may be, but is not limited to, 1:10 to 1:30 or 1:20 to 1:30.

In an example embodiment, the secondary heat treatment of the operation (S3) may be performed at 600 to 1000° C., and specifically may be performed at 700 to 1000° C. A secondary heat treatment time may be changed by a heat treatment temperature, and may be, for example, 1 to 15 hours or 1 to 10 hours, but is not necessarily limited thereto.

Preferably, the secondary heat treatment may be performed at 700 to 900° C. for 3 to 9 hours, and more preferably, the secondary heat treatment may be performed at 700 to 900° C. for 5 to 8 hours.

The producing method according to an example embodiment may further comprise an operation (S4) of treating the alloy particles produced by the secondary heat treatment with acid. In a specific example, the acid treatment may be performed using an acid solution comprising one or more acids selected from perchloric acid, hydrochloric acid, sulfuric acid, phosphoric acid, and nitric acid, and here, the concentration of the acid solution may be 0.05 to 5 M, and specifically, 0.1 to 3 M.

The present disclosure provides an electrode comprising the composite as described above. The electrode may be comprised in an energy conversion device. For example, in a fuel cell comprising an anode that produces hydrogen ions and electrons by oxidation of a fuel material, a cathode in which reduction of oxygen occurs by reaction with hydrogen ions and electrons, and an electrolyte layer (membrane) that may efficiently transfer hydrogen ions from the anode to the cathode, the electrode may be applied to the cathode of the fuel cell to improve not only the efficiency but also the stability of the fuel cell.

The present disclosure provides an energy conversion device comprising the electrode as described above, and since the energy conversion device comprises the electrode comprising the composite, the performance may be improved, and in particular, the durability may be significantly improved and the performance of the energy conversion device may be maintained for a long time. Specifically, there is an advantage of high retention rates of electrochemical active surface area (ECSA), maximum power density, and activity per unit mass (or mass activity) even after an accelerated durability test (ADT) under harsh conditions.

Here, the energy conversion device may comprise a fuel cell or a water electrolysis cell. Examples of fuel cells comprise, but are not limited to, a proton exchange membrane fuel cell (PEMFC), a direct methanol fuel cell (DMFC) that uses alcohol as fuel, a direct ethanol fuel cell (DEFC), an alkaline fuel cell (AFC), a phosphoric acid fuel cell (PAFC), a molten carbonate fuel cell (MCFC), and a solid oxide fuel cell (SOFC). Specifically, the fuel cell may be the PEMFC that operates at a low temperature and may be applied to a means of transportation, and the PEMFC may comprise a first gas diffusion layer, an anode, a polymer electrolyte membrane, a cathode, and a second gas diffusion layer.

Here, hydrogen, which is a fuel material, may be supplied to the anode through the first gas diffusion layer, and the supplied hydrogen may be oxidized at the anode and hydrogen ions may be transferred to the cathode through the polymer electrolyte membrane. The hydrogen ions on the cathode may react with oxygen supplied to the cathode through the second gas diffusion layer as described above to generate water. Here, the stability of the fuel cell may be improved by the composite according to the present disclosure comprised in the cathode, which has excellent catalytic activity for oxygen reduction reaction and remarkably excellent durability.

The first gas diffusion layer and the second gas diffusion layer may be formed of a material widely known in the art, through which the supplied fuel material, air, or oxygen may be smoothly supplied, and which has electrical conductivity, but the present disclosure is not limited thereto.

The polymer electrolyte membrane may be applied to the fuel cell field, and any polymer material known in the art may be applied without limitation. Examples of the polymer material may comprise, but are not limited to, sulfonated benzimidazole-based polymers, sulfonated polyimide-based polymers, sulfonated polyetherimide-based polymers, sulfonated polyphenylene sulfide-based polymers, sulfonated polysulfone-based polymers, sulfonated polyether-based polymers, sulfonated polyetherketone-based polymers, sulfonated polyether-etherketone-based polymers, sulfonated polyethersulfone-based polymers, sulfonated polyphenylquinoxaline-based polymers, and polymers with partially fluorinated sulfonated polymers.

As described above, the energy conversion device of the present disclosure may have improved performance and, in particular, may have significantly improved durability by comprising the composite of the present disclosure. Specifically, even after an accelerated durability test (ADT) of 30,000 cycles under harsh conditions, the energy conversion device may have low decrease rates in electrochemical active surface area (ECSA), maximum power density, and mass activity. Here, as the performance conditions of the ADT, those suggested by the Department of Energy (DOE) of the United States may be applied, and specifically, the ADT may be performed under 80° C. and ambient pressure, while supplying pure hydrogen with a relative humidity of 100% to the anode at a flow rate of 100 cm³/min. and supplying pure nitrogen with a relative humidity of 100% to the cathode at a flow rate of 50 cm³/min., and one cycle of the ADT may comprise a holding section of 3 seconds at 0.6 V, a rising section of 0.5 seconds, and a holding section of 3 seconds at 0.95 V.

For example, the energy conversion device may have a maximum power density retention rate of 85% or more, specifically 90% or more, and more specifically 94% or more, compared to that before the ADT, after an accelerated durability test of 30,000 cycles.

In addition, the energy conversion device may have an electrochemical active surface area (ECSA) retention rate of 60% or more, specifically 70% or more, more specifically 80% or more, and more specifically 90% or more, compared to those before the ADT, after the accelerated durability test of 30,000 cycles.

In addition, the energy conversion device may have a retention rate of activity per unit mass at 0.9 V of 60% or more, specifically 65% or more, and more specifically 70% or more, compared to that before the ADT, after the accelerated durability test of 30,000 cycles.

Hereinafter, Examples and Experimental Examples are described in detail. However, the Examples and Experimental Examples described below are only illustrative, and the technology described in this specification is not limited thereto.

### <Example 1> L1₀-N—PtCo—H/C NP

0.1 mmol of platinum (II) acetylacetonate, 0.1 mmol of cobalt (II) acetylacetonate, and 10 ml of oleylamine were added to a 50 ml vial and mixed to prepare a precursor solution. The precursor solution was sonicated for 10 minutes, and then a specific amount of carbon (Ketjen Black EC300JD) was added so that a total metal loading could be about 20 wt %, and then additionally sonicated for 20 minutes to prepare a reaction solution.

Thereafter, the reaction solution was heated at 190° C. for 5 hours in an oil bath under vigorous stirring to prepare a first alloy solution (or A1-PtCo/C solution) supported on a carbon support. After cooling the first alloy solution to room temperature, a mixture of 5 ml of hexane and 15 ml of ethanol was added to the resulting solution to precipitate the first alloy particles (or A1-PtCo/C NP) supported on the carbon support. Thereafter, the first alloy particles were obtained by centrifugation at 14,000 rpm for 10 minutes, washed three times with the mixture of hexane and ethanol, and dried overnight under N2 conditions.

The dried powder was first heat-treated at 450° C. for 2 hours under NH₃ gas to obtain the second alloy particles (or A1-N—PtCo/C NP) doped with nitrogen.

Thereafter, the second alloy particles were secondly heat-treated under a reducing atmosphere and a temperature of 700° C. for 6 hours to prepare a composite (or L1₀-N—PtCo—H/C NP) supported on the carbon support in which a phase transformation occurred. Here, the reducing atmosphere means that a reducing gas comprising 96 vol % of argon and 4 vol % of hydrogen was supplied.

A schematic diagram of sequential processes of producing the composite is illustrated in FIG. 1.

### Example 2

A composite (or N—PtCo-1000 (1)/C NP) in which a phase transformation occurred was produced in the same manner as in Example 1, except that the second heat treatment was performed at 1000° C. for 1 hour.

### Example 3

A composite (or N—PtCo-700 (3)/C NP) in which a phase transformation occurred was produced in the same manner as in Example 1, except that the second heat treatment was performed at 700° C. for 3 hours.

### Example 4

A composite (or N—PtCo-700 (9)/C NP) in which a phase transformation occurred was produced in the same manner as in Example 1, except that the second heat treatment was performed at 700° C. for 9 hours.

### <Comparative Example 1> A1-PtCo/C NP

A first alloy particle (or A1-PtCo/C NP) supported on the carbon support was produced in the same manner as in Example 1, except that neither the first heat treatment nor the second heat treatment was performed.

### <Comparative Example 2> A1-N—PtCo/C NP

A second alloy particle (or A1-N—PtCo/C NP) doped with nitrogen was produced in the same manner as in Example 1, except that the second heat treatment was not performed.

### <Comparative Example 3>L10-N—PtCo-L/C NP

A composite (or L1₀-N—PtCo-L/C NP) in which a phase transformation occurred was produced in the same manner as in Example 1, except that the second heat treatment was performed at 700° C. for 1 hour.

### <Comparative Example 4>L10-PtCo/C NP

A composite (or L1₀-PtCo/C NP) in which a phase transformation occurred was produced in the same manner as in Example 1, except that the first heat treatment was not performed.

### Examples 5 to 8, Comparative Examples 5 to 8

The composite of Example 1 was acid-treated (etched) at 60° C. for 24 hours in 0.1 M HClO₄ to produce a core-shell structured composite of Example 5 (or L10-N—PtCo—H@Pt/C).

The same acid treatment was applied to each of the composites of Examples 2 to 4 to produce the composites having a core-shell structure of Examples 6 to 8.

In addition, the same acid treatment was applied to each of the finally produced particles of Comparative Examples 1 to 4 to produce the composites having a core-shell structure of Comparative Examples 5 to 8. The composites having a core-shell structure of Comparative Examples 5 to 8 are denoted as A1-PtCo@Pt/C, A1-N—PtCo@Pt/C, L1₀-N—PtCo-L@Pt/C, L1₀-PtCo—H@Pt/C, respectively.

### <Comparative Example 9> Commercial Pt/C

An experimental example was performed using commercial Pt/C (19.4 wt % Pt, Tanaka Holdings Co., Ltd).

### <Experimental Example 1> Structural Characteristics and Morphology Analysis

First, a crystal structure of the materials produced in Examples and Comparative Examples was checked using X-ray diffraction (XRD, Rigaku Smartlab, kV, 30 mA, 4° min⁻¹, Cu-Kα radiation, λ=1.55406 Å) analysis. FIG. 2 is a drawing illustrating XRD patterns of Comparative Examples 1 to 3 and Example 1. Referring to this, in the case of Comparative Example 1 in which neither the first heat treatment under NH₃ gas nor the second heat treatment under H₂ gas was performed, an alloy having an A1-type face-centered cubic (fcc) structure was formed. In addition, in the case of Comparative Example 2 in which only the first heat treatment was performed, no superlattice XRD peak was observed, indicating that an alloy disorder of the A1-type fcc structure was maintained. In the case of Example 1 in which both the first and second heat treatments were performed, peaks appeared at 24.03° and 33.32° corresponding to the superlattice (001) and (110) of the fct (face-centered tetragonal) PtCo (PDF #03-065-8969), respectively. In addition, it was confirmed that, when the second heat treatment was performed at 500 to 1000° C. in 100° C. intervals for 1 to 12 hours, the aforementioned superlattice peaks appeared at all temperatures except for 500° C. Through this, it can be seen that a phase transformation from the disordered A1-type fcc structure to the regular L1₀-type fct structure occurs when the second heat treatment is performed at a temperature of 600° C. or higher. In the case of Comparative Example 3, when both the first and second heat treatments were performed, the aforementioned superlattice peaks appeared, similar to Example 1. However, a difference is observed in that the (111) peak of Example 1 has a slightly higher 20 value than the peak of Example 3.

Next, proportions (%) of the degree of ordering of the Examples and Comparative Examples were calculated, and the results are summarized in Table 1 below. The proportions (%) of the degree of ordering expressed as a percentage is a value obtained by dividing the value of the degree of ordering of the Examples and Comparative Examples calculated by the formula below by 0.1913, which is a value of the degree of ordering of L1₀ fct PtCo (PDF #03-065-8969) to obtain a resultant value, and then multiplying the resultant value by 100. S₍₁₁₀₎, S₍₁₁₁₎, S₍₂₀₀₎, and S₍₀₀₂₎ represent the integrated areas of the (110), (111), (200), and (002) peaks, respectively.

The degree of ordering=S₍₁₁₀₎/(S₍₁₁₁₎+S₍₂₀₀₎+S₍₀₀₂₎)

TABLE 1

| | Proportion of degree of ordering |
|---|---|
| Example 1 | 74% |
| Example 2 | 65% |
| Example 3 | 47% |
| Example 4 | 42% |
| Comparative Example 1 | 0% |
| Comparative Example 2 | 0% |
| Comparative Example 3 | 22% |

Next, magnetism of the materials produced in Examples and Comparative Examples was measured. To this end, the magnetic hysteresis loops were measured through a magnetic property measurement system (MPMS) using quantum design/MPMS3 with a field of up to 70 kOe. FIG. 3 is a diagram illustrating magnetic hysteresis loops of Comparative Examples 1 to 3 and Example 1. Referring to this, in the case of Comparative Examples 1 and 2 having the A1-type fcc structure, the coercivity is 0, which is superparamagnetic, in the case of Comparative Example 3, the coercivity is 5.2 kOe, and in the case of Example 1, the coercivity is 21.8 kOe, which is very high ferromagnetism. The coercivity value appears to increase in proportion to the degree of ordering due to the formation of a pinning site of a magnetic domain wall originating from a square c-axis boundary of the L1₀ structure. Through this, it can be seen that Comparative Examples 1 and 2, have no degree of ordering at all, and Comparative Example 3 has a low degree of ordering, compared to Example 1.

Next, the change in the lattice configuration according to the process of producing the composite according to Examples was examined. Specifically, X-ray absorption spectroscopy (XAS) using Demeter software at Pohang Accelerator Laboratory (PAL) was used. FIG. 4 is a unit cell schematic model illustrating changes in lattice parameters and atomic arrangements according to the first and second heat treatments of Example 1. FIG. 5 is a diagram illustrating Pt L₃-edge FT-EXAFS spectra of Comparative Example 1, Comparative Example 2, and Example 1. Referring to FIG. 4, when platinum and a metal (Co) other than platinum form an alloy, a lattice contraction occurred to the lattice parameter a of 3.826 Å, compared to pure Pt (3.948 Å) due to a short bond length of the metal (Co) other than platinum. Thereafter, when the first heat treatment was performed under NH₃ gas, a lattice expansion occurred to the lattice parameter a of 3.833 Å due to nitrogen doping. When the second heat treatment in which a phase transformation from the A1-type structure to the L1-type structure occurred, the lattice contraction occurred more strongly to the lattice parameter a of 3.808 Å. This tendency may also be confirmed in FIG. 5. In detail, deconvolution of the peaks in the spectrum of FIG. 5 into Pt—Pt bond peaks and Pt—Co bond peaks showed that the Pt—Pt bond lengths of Pt foil, A1-PtCo/C, A1-N—PtCo/C, and L10-N—PtCo—H/C were 2.764 Å, 2.714 Å, 2.723 Å, and 2.696 Å, respectively.

Next, it was confirmed that a bond between nitrogen and a metal other than platinum was formed through the first heat treatment under NH₃ gas. In other words, it was confirmed that nitrogen doping was performed on an alloy of platinum and a metal other than platinum, specifically, on a metal other than platinum. To this end, Raman spectroscopy was used, and specifically, the Raman spectrum was collected from a Raman spectrometer (NICOLET ALMECA XR) manufactured by Thermo Scientific using a 532-nm laser beam therefor. FIG. 6 is a drawing illustrating the Raman spectra of Comparative Example 1, Comparative Example 2, and Example 1. Referring to this, unlike Comparative Example 1, it can be seen that in Comparative Example 2 and Example 1 have the characteristic peaks of Co—N at 473 cm⁻¹ and 513 cm⁻¹, indicating that cobalt nitride is formed. In other words, it can be seen that nitrogen doping was successfully performed. In addition, the characteristic peak of Co—N of Example 1 shows a greater intensity than that of Comparative Example 2.

Next, characteristics of the morphology of Example 5 formed after the final acid treatment (etching) was analyzed. Specifically, high-angle annular dark-field scanning transmission electron microscopy (HAADF-STEM) (FEI Themis Z) and energy-dispersive X-ray spectroscopy (EDS) (FEI Themis Z) were used. FIG. 7 is an atomic-resolution HAADF-STEM image of the core-shell structured composite of Example 5, and FIGS. 8 and 9 are drawings illustrating intensity profiles at lines 1 and 2 indicated in FIG. 7. FIGS. 10 and 11 are drawings illustrating composition profiles and EDS elemental mapping images of Pt and Co at the lines indicated in the HAADF-STEM image, respectively. Referring to FIG. 7, the composite of Example 5 was obtained by acid treatment (etching) of the composite of Example 1 and has a core-shell structure with lattice spacings of 0.261 nm and 0.368 nm corresponding to (110) and (001) superlattices, which is supported by the alternating appearance of Pt atoms and Co atoms surrounded by Pt shells of 2 to 3 atomic layers. In addition, referring to a fast Fourier transform (FFT) pattern of Example 5, which is an image inserted in FIG. 7, it can be seen that a highly ordered L1₀ type intermetallic fct structure was successfully formed. Referring to FIGS. 8 and 9, the detailed atomic arrangement of the particles of Example 5 can be seen, and the presence of regular Pt atoms (line profile 1) and stacked Pt/Co atoms in a specific direction may be confirmed in detail. Referring to FIGS. 10 and 11, it can be seen that Pt and Co atoms are distributed together in a core of the composite, Pt atoms are abundantly distributed in a shell portion, and nitrogen atoms are mainly distributed in the core.

Next, XAS analysis was used to examine surface characteristics of Example 5 in detail. Specifically, Pt L3-edge XANES spectra of each of Pt foil, PtO₂, commercial Pt/C, and Example 5 were measured and shown in FIG. 12. Referring to this, it can be seen that a white line peak intensity of Example 5 is significantly lower than that of PtO₂ and commercial Pt/C and is substantially the same as that of Pt foil. That is, it can be seen that the Pt surface of the core-shell structured composite according to Example 5 exists in a metallic Pt form advantageous for ORR electrocatalysis. Meanwhile, in the core region of Example 5, a Pt—Pt bond length is shortened as the degree of ordering increases, which is similar to the tendency examined in FIG. 4. In summary, it is considered that the ORR activity is promoted as the degree of ordering increases due to the strong electronic interaction between Pt and Co atoms and the lattice mismatch between the core and shell regions.

### <Experimental Example 2> Evaluation of Chemical Stability

The chemical stability of the core-shell structured composites of Examples and Comparative examples was evaluated in an environment similar to a strongly acidic fuel cell environment. Specifically, the composites of Example 5 and Comparative Examples 6 to 8 were etched in a 0.1 M of perchloric acid (HClO₄) aqueous solution (60° C.) for 24 hours, and then an elemental composition was measured by inductively coupled plasma-optical emission spectroscopy (ICP-OES) (Thermo Scientific iCAP7400). Thereafter, a preservation rate of metal Co other than platinum was calculated by dividing the number of atoms of the metal other than platinum after etching under the aforementioned conditions by the number of atoms of the metal other than platinum before etching to obtain a resultant value and multiplying the resultant value by 100, and the results are summarized in FIG. 13 and Table 2. Referring to FIG. 13 and Table 2, it can be seen that the composite of the present disclosure has high ordering and nitrogen doping characteristics, and thus 25 the elution of the metal forming an alloy with platinum is effectively suppressed under strong acid conditions, such as a fuel cell environment, and thus, the composite is chemically stable.

TABLE 2

| | Preservation rate of metal other than platinum |
|---|---|
| Example 5 | 90% |
| Comparative Example 6 | 26% |
| Comparative Example 7 | 60% |
| Comparative Example 8 | 74% |

### <Experimental Example 3> Evaluation of Fuel Cell Performance

For the performance test of a proton exchange membrane fuel cell (PEMFC), a membrane electrode assembly (MEA) was produced using a catalyst-coated membrane (CCM) having an active area of 5 cm². Commercial Pt/C (19.4 wt % Pt, Tanaka Holdings Co., Ltd) was used as an anode catalyst. The composites produced in Examples or Comparative Examples were used as the cathode catalyst. The CCM was prepared by mixing each catalyst in deionized water, 2-propanol, and 5 wt % of Nafion solution to prepare a slurry, spray-coating the prepared slurry on a Nafion N211 membrane, and drying the same on a hot plate at 60° C. for several hours. The catalyst loading amounts were 0.05 and 0.10 mgPt/cm2 for the anode and cathode, respectively. The membrane electrode assembly was then assembled with a commercial gas diffusion layer (GDL, SGL 39 BB) without hot-pressing.

The PEMFC was operated at 80° C. and a back pressure of 150 kPa_{abs} by supplying pure hydrogen with 100% relative humidity to the anode at a flow rate of 300 cm³/min and pure oxygen with 100% relative humidity to the cathode at a flow rate of 1000 cm³/min.

To evaluate the durability of the catalyst, an accelerated durability test (ADT) was performed based on the cyclic voltammetry (CV) cycle for 30 k proposed by the Department of Energy (DOE). According to an electrocatalytic cycling protocol, the ADT was performed between 0.6 V and 0.95 V with a hold time of 3 seconds at both potentials, while supplying pure hydrogen with 100% relative humidity to the anode at a flow rate of 100 cm³/min. and supplying pure nitrogen with 100% relative humidity to the cathode at a flow rate of 50 cm³/min. under ambient pressure at 80° C. A rise time between the two potentials was 0.5 seconds. The CV and polarization curves were measured every 10,000 cycles. The CV was performed at 80° C. without back pressure at a scan range of 0.1 to 1.2 V and a scan rate of 50 mV/s. Chronopotentiometry was performed at 80° C. for 100 h at a constant current density of 1.0 A/cm², while H₂ and air with a relative humidity of 100% were supplied to the anode and cathode at flow rates of 300 and 1000 cm³/min., respectively, and a back pressure of 150 kPa_{abs}.

First, the catalytic activity of the fuel cells to which Examples and Comparative Examples were applied as catalysts for the oxygen reduction reaction (ORR) was evaluated. FIG. 14 is a diagram illustrating polarization curves and power density curves of the fuel cells to which Example 5 and Comparative Examples 6 to 9 were applied as cathode catalysts. FIG. 15 is a diagram illustrating the mass activity and peak power density (Pₘₐₓ) at 0.9 V of the fuel cell to which Example 5 and Comparative Examples 6 to 9 were applied as cathode catalysts, respectively. Referring to this, it was found that the fuel cells to which Example 5 and Comparative Example 8 were applied had significantly higher mass activity and peak power density than the other Comparative Examples due to the high degree of ordering. Next, the durability of the fuel cells to which the Examples and Comparative

Examples were applied as catalysts was evaluated, and the results are summarized in FIGS. 16 to 18 and Table 3 below. FIGS. 16 to 18 are diagrams illustrating the performance at a start point (BOT) and an end point (EOT) of ADT performed for 30 k cycles of the fuel cells to which Example 5, Comparative Examples 8 and Comparative Examples 9 were applied as cathode catalysts, respectively. FIGS. 16 to 18 relate to the mass activity, maximum power density (Pₘₐₓ), and electrochemical active surface area (ECSA), respectively.

TABLE 3

| | | | | | Retention | | Retention |
|---|---|---|---|---|---|---|---|
| | | MA | Retention rate | Pₘₐₓ | rate of | ESCA | rate of |
| | | (A/mg_{Pt}) | of MA (%) | (W/cm²) | Pₘₐₓ (%) | (m²/g_{Pt}) | ESCA (%) |
| Example 5 | BOT | 0.64 | — | 1.57 | — | 36.2 | — |
| | EOT | 0.46 | 72 | 1.48 | 94 | 32.8 | 91 |
| Comparative | BOT | 0.70 | — | 1.58 | — | 39.1 | — |
| Example 8 | EOT | 0.32 | 46 | 1.33 | 84 | 17.2 | 44 |
| Comparative | BOT | 0.22 | — | 1.38 | — | 58.9 | — |
| Example 9 | EOT | 0.11 | 50 | 0.96 | 70 | 13.5 | 23 |

Referring to FIGS. 16 to 18 and Table 3, it can be seen that when Example 5 was applied to a fuel cell, it the durability is better than that of Comparative Example 8 so that the durability improvement effect due to nitrogen doping is excellent.

The remarkably excellent durability of the core-shell composite of Example after long-term cycling may be explained by the fact that an average particle diameter at BOT increased from 6.37 nm to 6.91 nm at EOT, which is a 1.08-fold increase, and a size growth was significantly suppressed. Meanwhile, in the case of Comparative Example 8, the average particle diameter significantly increased from 6.71 nm to 8.37 nm, and agglomeration between particles occurred a lot. Here, the average particle diameter was measured from a transmission electron microscope (TEM, FEI Tecnai G2 twin) image.

In addition, in order to set the fuel cell to operate in a natural environment, air was supplied to the cathode side and the results are shown in FIGS. 19 and 20. FIG. 19 is a diagram illustrating voltage loss according to the ADT performance of the fuel cells to which Example 5, Comparative Example 8, and Comparative Example 9 were applied as cathode catalysts, respectively. It was performed under various current density conditions. Referring to FIG. 19, Example 5 showed the minimum voltage loss over the entire current density, while Comparative Examples 8 and 9 showed severe deterioration. FIG. 20 is a diagram illustrating the results of the long-term steady-state evaluation of fuel cells to which Example 5 and Comparative Example 9 were applied as cathode catalysts. Referring to FIG. 20, Example 5 was able to operate with only a 8% voltage drop even after 100 hours, while Comparative Example 9 was able to operate with a 18% voltage drop.

In summary, it can be seen that the composite according to an example embodiment may have significantly improved durability while maintaining excellent catalytic activity of the catalyst by comprising nitrogen-doped nanoparticles while having a high degree of ordering.

The composite according to the present disclosure may have significantly improved catalytic activity and durability by comprising nitrogen-doped nanoparticles while having a high degree of ordering.

Hereinabove, although the present disclosure has been described by specific matters and limited example embodiments, they have been provided only for assisting in the entire understanding of the present disclosure. Therefore, the present disclosure is not limited to the example embodiments. Various modifications and changes may be made by those skilled in the art to which the present disclosure pertains from this description.

1. A composite comprising:
a carbon support and a nitrogen-doped nanoparticle supported on the carbon support,
wherein the nanoparticle comprises an alloy comprising platinum and a metal other than platinum and has a coercivity of 7 kOe or more.

2. The composite of claim 1, wherein
the metal other than the platinum is at least one metal selected from the group consisting of vanadium (V), chromium (Cr), iron (Fe), ruthenium (Ru), cobalt (Co), rhodium (Rh), iridium (Ir), nickel (Ni), palladium (Pd), copper (Cu), molybdenum (Mo), tungsten (W), yttrium (Y), scandium (Sc), zirconium (Zr), niobium (Nb), zinc (Zn), silver (Ag), gold (Au), antimony (Sb), cerium (Ce), and lanthanum (La).

3. The composite of claim 1, wherein
the alloy is an intermetallic compound of platinum and a metal other than platinum.

4. The composite of claim 1, wherein
the composite has a peak in a range of 2θ=33.32±1° in an X-ray diffraction (XRD) spectrum.

5. The composite of claim 1, wherein
the composite has a proportion of a degree of ordering of 40% or more.

6. The composite of claim 1, wherein
a ratio (I₁/I₂) of a maximum peak intensity (I₁) appearing in an X-ray absorption near-edge structure (XANES) spectrum of the composite to a maximum peak intensity (I₂) appearing in a spectrum of pure platinum (Pt) is 1.3 or less.

7. The composite of claim 1, wherein
a preservation rate of metals other than platinum measured after etching in a 0.1 M of perchloric acid (HClO₄) solution for 24 hours is 70% or more.

8. The composite of claim 1, wherein
the nanoparticle comprises 1 to 20 atomic % of nitrogen.

9. The composite of claim 1, wherein
a chemical bond is formed with nitrogen and a metal other than platinum.

10. The composite of claim 1, wherein
the nanoparticle has an average particle diameter of 0.1 to 20 nm.

11. The composite of claim 1, further comprising:
a platinum shell on a surface of the nanoparticle.

12. The composite of claim 1, wherein
the composite is a catalyst for an oxygen reduction reaction.

13. A method for producing a composite, the method comprising:
an operation (S1) of producing a first alloy particle supported on a carbon support from a reaction solution comprising a carbon support, a platinum precursor, and a metal precursor other than platinum;
an operation (S2) of producing a nitrogen-doped second alloy particle by first heat treatment of the first alloy particle under a nitrogen-containing gas; and
an operation (S3) of secondary heat treatment of the nitrogen-doped second alloy particle under a reducing atmosphere.

14. The method of claim 13, wherein
coercivity of the first alloy particle and the nitrogen-doped second alloy particle is less than 1 kOe, and coercivity of the composite is 7 kOe or more.

15. The method of claim 13, wherein
the reaction solution of the operation (S1) further comprises a surface stabilizer.

16. The method of claim 13, wherein
the first heat treatment of the operation (S2) is performed at 300 to 600° C.

17. The method of claim 13, wherein
the reducing atmosphere of the operation (S3) comprises hydrogen.

18. The method of claim 13, wherein
the secondary heat treatment of the operation (S3) is performed at 600 to 1000° C.

19. An electrode comprising the composite according to claim 1.

20. An energy conversion device comprising the electrode according to claim 19.
